(19) United States
(12) Patent Application Publication
(10) Pub. No.: US 2022/0061463 A1
(43) Pub. Date: Mar. 3, 2022

(54) SYSTEMS AND METHODS FOR CUSTOM FOOTWEAR, APPAREL, AND ACCESSORIES

(71) Applicant: Vans, Inc., Costa Mesa, CA (US)

(72) Inventors: Craig D. Vanderoef, Costa Mesa, CA (US); Safir Bellali, Pasadena, CA (US); Longtao Wang, Alhambra, CA (US); Henry Song, Glendale, CA (US)

(21) Appl. No.: 17/461,699

(22) Filed: Aug. 30, 2021

Related U.S. Application Data
(60) Provisional application No. 63/072,645, filed on Aug. 31, 2020.

(51) Int. Cl. A43D 1/02; A43B 1/04; G06T 15/20; G06T 17/00; G06T 7/00; G06N 20/00

(52) U.S. Cl. CPC A43D 1/025; A43B 1/04; G06T 15/205; G06T 17/00; G06T 2207/20081; G06N 20/00; A43D 2200/60; G06T 2210/16; G06T 7/0002

(57) ABSTRACT

An example method may comprise determining, based at least on one or more images, one or more areas of wear indicative of worn portions of an article such as an article of footwear. The example method may comprise mapping the one or more areas of wear to a two dimensional wear model. The example method may comprise determining, based at least on the one or more images, a severity of wear of one or more of the one or more areas of wear. The example method may comprise determining, based on the two dimensional wear model and the severity of wear of each of the one or more areas of wear, a pattern for a custom article. The example method may comprise outputting a machine-readable code representing the pattern. The machine-readable code may be configured to be processed by a machine to cause manufacture of at least a portion of the custom article.

### CROSS REFERENCE TO RELATED APPLICATIONS

This application is a non-provisional of and claims the benefit of U.S. Provisional Application No. 63/072,645 filed Aug. 31, 2020, which is hereby incorporated by reference in its entirety.

### BACKGROUND

Current custom manufacturing for footwear, apparel, and accessory, for example, have shortcomings.

Relevant to the systems and/or methods described herein is U.S. Pat. Pub. No. 2017/0272728, titled “System and method of three-dimensional scanning for customizing footwear”, and dated Sep. 21, 2017, the abstract of which is reproduced here. A method for generating shoe recommendations includes: capturing, by a scanning system, a plurality of depth maps of a foot, the depth maps corresponding to different views of the foot; generating, by a processor, a 3D model of the foot from the plurality of depth maps; computing, by the processor, one or more measurements from the 3D model of the foot; computing, by the processor, one or more shoe parameters based on the one or more measurements; computing, by the processor, a shoe recommendation based on the one or more shoe parameters; and outputting, by the processor, the shoe recommendation.

Relevant to the systems and/or methods described herein is U.S. Pat. No. 10,269,174, titled “Manufacturing a customized sport apparel based on sensor data”, and dated Apr. 23, 2019, the abstract of which is reproduced here. An article of sports apparel being customized for a person is provided, and may be manufactured based on a digital model, the digital model built based on received sensor data, the received sensor data obtained by at least one sensor integrated into another article of sports apparel, and the sensor data is obtained while the other article of sports apparel is worn by the person during a sports activity.

Relevant to the systems and/or methods described herein is U.S. Pat. No. 9,460,557, titled “Systems and methods for footwear fitting”, and dated Oct. 4, 2016, the abstract of which is reproduced here. Systems and methods are disclosed for best fitting a subject to a one of a plurality of object variations by capturing images of a user anatomical portion and a reference object from a plurality of angles using a mobile camera; creating a 3D model of the user anatomical portion from the images with dimensions based on dimensions of the reference object; and selecting a best-fit physical object from the plurality of object variations based on the 3D model.

Relevant to the systems and/or methods described herein is U.S. Pat. No. 9,788,600, titled “Customized footwear, and systems and methods for designing and manufacturing same”, and dated Oct. 17, 2017, the abstract of which is reproduced here. The invention relates to devices and methods for designing and manufacturing customized footwear, and components thereof. An example method includes a method of designing at least a portion of a sole of an article of footwear customized for a user. The method includes the steps of determining at least one input parameter related to a user, analyzing the at least one input parameter to determine at least one performance metric of a foot of the user, and determining at least one customized structural characteristic of at least a portion of a sole of an article of footwear for the user based on the performance metric.

Relevant to the systems and/or methods described herein is U.S. Pat. Pub. No. 2016/0219972, titled “Improvements in and relating to footwear and foot wear analysis”, and dated Aug. 4, 2016, the abstract of which is reproduced here. A shoe comprising a shoe insole for receiving a foot and shoe outsole for ground engagement by the wearer of the shoe, the outsole including a plurality of discrete wear depth indicator datums indicative of outsole wear at each such datum, the datums being arranged at positions below the foot prone to wear, such as under the heel, to thereby provide a visual indication of wear over time at each such datum. The invention also extends to a method of analysing the wear pattern of the wear indication datums of a shoe, including the steps of providing a reference 3D geometry of the sole of the unworn shoe on a computer, thereafter uploading subsequent 3D geometry of the sole of the shoe at intervals during the life of the shoe and comparing such geometry with the reference to thereafter ascertain the wear pattern across the sole for the wearer of the shoe.

Relevant to the systems and/or methods described herein is U.S. Pat. No. 9,122,819, titled “Customized shoe textures and shoe portions”, and dated Sep. 1, 2015, the abstract of which is reproduced here. A shoe with a three-dimensional (3-D) surface texture created using rapid manufacturing techniques is provided. A plurality of 3-D surface texture options is presented on a user interface; each of the options is associated with one of a plurality of 3-D surface textures to be applied to a portion of a shoe. A selection of a 3-D surface texture is received and is used in part to generate a design file. The design file is used to instruct a rapid manufacturing device to manufacture the portion of the shoe comprised of the 3-D surface texture using a rapid manufacturing technique.

Relevant to the systems and/or methods described herein is U.S. Pat. No. 5,894,682, titled “Shoe with built-in diagnostic indicator of biomechanical compatibility, wear patterns and functional life of shoe, and method of construction thereof”, and dated Apr. 20, 1999, the abstract of which is reproduced here. The invention provides a shoe having a built-in wear-indicator device capable of signalling (a) extent of shoe wear, (b) biomechanical compatibility with the user, (c) loss of the ability to cushion and absorb shock, and (d) a need for shoe replacement. The built-in wear-indicator device is positioned within the midsole and/or outsole and must be made of a material that is less compactible than the surrounding bulk midsole material that functions conventionally to cushion and absorb shock. With prolonged wear the midsole material loses its ability to absorb shock and compacts in the vertical dimension. In contrast, the wear-indicator device, being less compactible than the midsole, continues to protrude into the outsole in response to downward forces exerted on the indicator device. The degree of extension of the wear-indicator device into the outsole is an indicator of loss of ability to cushion and absorb shock and, consequently, of a need for shoe replacement. The invention further provides a shoe having a built-in wear-indicator outsole capable of detecting erosion of the shoe outsole surfaces, which is correlated with midsole compaction and loss of ability to cushion and absorb shock.

Improvements are needed.

### SUMMARY

Described herein are systems and/or methods of making custom knit footwear.

An example method may comprise receiving one or more images of three-dimensional footwear. The example method may comprise determining, based at least on the one or more images, one or more areas of wear indicative of worn portions of the footwear. The example method may comprise mapping the one or more areas of wear to a two dimensional wear model. The example method may comprise determining, based at least on the one or more images, a severity of wear of each of the one or more areas of wear. The example method may comprise determining, based on the two dimensional wear model and the severity of wear of each of the one or more areas of wear, a knit pattern for a custom knit upper. The example method may comprise outputting a machine-readable code representing the knit pattern. The machine-readable code may be configured to be processed by a knitting machine to cause knitting of at least a portion of the custom knit upper.

Described herein are systems and/or methods of making custom footwear. An example method may comprise determining, based at least on one or more images of footwear, one or more areas of wear indicative of worn portions of the footwear. The example method may comprise mapping the one or more areas of wear to a two dimensional wear model. The example method may comprise determining, based at least on the one or more images, a severity of wear of one or more of the one or more areas of wear. The example method may comprise determining, based on the two dimensional wear model and the severity of wear of each of the one or more areas of wear, a pattern for a custom upper. The example method may comprise outputting a machine-readable code representing the pattern. The machine-readable code may be configured to be processed by a machine to cause manufacture of at least a portion of the custom upper.

Described herein are systems and/or methods of making custom footwear. An example method may comprise receiving one or more images of three-dimensional footwear; determining, based at least on the one or more images, one or more areas of wear indicative of worn portions of the footwear; mapping the one or more areas of wear to a two dimensional wear model; determining, based at least on the one or more images, a severity of wear of each of the one or more areas of wear; determining, based on the two dimensional wear model and the severity of wear of each of the one or more areas of wear, a pattern for custom footwear; and outputting a machine-readable code representing the pattern, wherein the machine-readable code is configured to be processed by a machine to cause formation of at least a portion of the custom footwear. As an example, the pattern may comprises an outsole or an upper, or both.

Described herein are methods of making a custom article. An example method may include receiving one or more images of a three-dimensional article; determining, based at least on the one or more images, one or more areas of wear indicative of worn portions of the article; mapping the one or more areas of wear to a two dimensional wear model; determining, based at least on the one or more images, a severity of wear of each of the one or more areas of wear; determining, based on the two dimensional wear model and the severity of wear of each of the one or more areas of wear, a pattern for a custom article; and outputting a machine-readable code representing the pattern, wherein the machine-readable code is configured to be processed by a machine to cause formation of at least a portion of the custom article.

### BRIEF DESCRIPTION OF THE DRAWINGS

The following drawings show generally, by way of example, but not by way of limitation, various examples discussed in the present disclosure. In the drawings:

FIG. 1 shows an example environment for making custom footwear.

FIGS. 2a-2d show example user interfaces for making custom footwear.

FIGS. 3a-3c show example applications for making custom footwear.

FIGS. 4a-4c show example mappings for making custom footwear.

FIG. 5 shows images of example severities of wear and tear of footwear.

FIG. 6 shows a flow diagram of an example method for making custom footwear.

FIG. 7 shows a flow diagram of an example method for making custom footwear.

### DETAILED DESCRIPTION

Skating is an art form. As an illustrative example, the way each skater grinds, kick-flips, and ollies their way through the streets and ramps creates a style and genre unique to them in the same way each brush stroke and chisel strike belong to Monet or Michelangelo. The medium that captures the skaters' art is not a flat canvas or a chunk of marble, but the shoes in which they skate. Each trick, each push, each grind. Even each fall and failed attempt leave a permanent mark on the shoes they skate in. Their art is etched in leather and canvas left as a reminder of what was and a hint at what is next. The shoe as canvas for the artwork of skating has one a fatal flaw, the shoe is fleeting and in the creation of their art they destroy the canvas itself in the moment of creation and so their ability to create is hindered.

As a further example, footwear, apparel, or accessories may experience wear in a manner that is particular to a wearer and/or a specific activity. As such, the present disclosure may be used for various articles.

Extending the skate example, the performance customization model of the present disclosure offers an innovative solution to the continuance of art through skating by using the skater's (or artist's) previous work as the means to create a new canvas; specifically, for them and their unique style of art through skating. Through image capture of the old shoe (the manifestation of the previous works) the systems and methods may determine how their creative expression wears and tears their current shoes and through a powerful algorithm create a new shoe pattern that may be more durable for their specific style of skating. This pattern may be directly sent to a knitting machine that may then knit highly specialized yarns in specific areas utilizing performance structures to extend the ability to create in the skater's key zones resulting in a fully knit shoe that is built to the needs of the individual skater's art.

This process may extend the longevity for each skater in a unique way and allows greater confidence for the skater that their product will move forward with them as they push the envelope of their art. This new process may make a real time connection to their skating in their past and their future via a truly unique model of product creation.

Although reference is made to footwear, and in particular skate footwear, the processes, systems, and methods of the present disclosure may be applied to various footwear, apparel, accessories, and articles of manufacture without departing from the spirit of the invention.

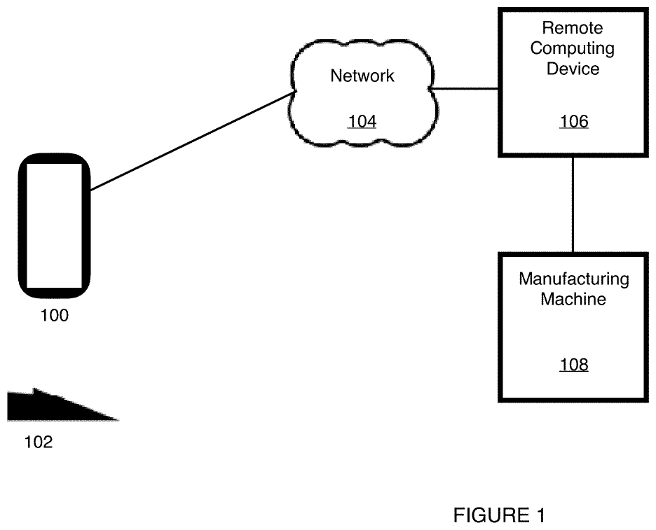

FIG. 1 shows an example environment for making custom articles such as footwear, apparel, or accessories, for example. The environment may comprise a user device 100, one or more articles such as shoes (e.g., footwear, etc.) 102, a network 104, a remote computing device 106, and a manufacturing machine 108. The user device 100 may execute an application. The application may be associated with a clothing manufacturer. The application may be associated with a shoe manufacturer. The application may allow a user to capture one or more images (e.g., pictures, visual representations, etc.) of the one or more shoes 102 and transmit the one or more images through the network 104 to the remote computing device 106. The user device 100 may comprise a smart phone, a tablet, a laptop, a desktop, or any device capable of executing the application.

The one or more shoes 102 may comprise a pair of shoes. The one or more shoes 102 may comprise shoes for skateboarding. The one or more shoes 102 may have wear and tear from use. Although reference to footwear, and illustrations thereof, are made herein, other articles such as apparel or accessories may be used.

At least a portion of the network 104 may comprise a private network. At least a portion of the network 104 may comprise a public network. At least a portion of the network 104 may comprise the internet.

The remote computing device 106 may be associated with a clothing manufacturer. The remote computing device 106 may be associated with a shoe manufacturer. The remote computing device 106 may comprise one or more servers. The remote computing device 106 may comprise a cloud computing environment. The remote computing device 106 may comprise a network of computing devices. The remote computing device 106 may comprise a deep learning architecture. The remote computing device 106 may comprise a convolutional neural network. The remote computing device 106 may be configured to communicate with instances of the application.

The remote computing device 106 may use computer vision to help identify areas of wear and/or to help define a severity associated with each identified area of wear. The remote computing device 106 may use image digitization to help identify areas of wear and/or to help define a severity associated with each identified area of wear. The remote computing device 106 may use image extraction to help identify areas of wear and/or to help define a severity associated with each identified area of wear. The remote computing device 106 may use image recognition to help identify areas of wear and/or to help define a severity associated with each identified area of wear.

The manufacturing machine 108 may comprise a knitting machine or other machine used in making or assembling footwear, apparel, or accessories. Although reference is made to knitting techniques, other manufacturing techniques or assembly techniques may be used, such as digital printing, robotic assembly, adhesive or welding, including sonic welding, techniques, laminating, etc. The manufacturing machine 108 may be in communication with the remote computing device 106. The manufacturing machine 108 may be in direct communication with the remote computing device 106. The manufacturing machine 108 may be in communication with the remote computing device 106 via a network, such as the network 104. The manufacturing machine 108 may take an image file (e.g., jpeg, bitmap, etc.) as input. The manufacturing machine 108 may take instructions (e.g., Make One (M1) patterns, Make-One-Left (M1L) patterns, etc.) as input. The manufacturing machine 108 may output instructions (e.g., Make One (M1) patterns, Make-One-Left (M1L) patterns, etc.). The manufacturing machine 108 may output manufactured (e.g., knitted, etc.) apparel, such an upper for footwear, a midsole, an outsole, an apparel component, or an accessory.

A user may have an article (e.g., a pair of shoes), such as the one or more shoes 102. The article may exhibit wear and tear from use. The user may execute an application on a user device, such as the user device 100. The application may be associated with a manufacturer of the article. The user may capture one or more images of the article with the user device and use the application to transmit the one or more images through a network, such as the network 104, to a cloud computing environment associated with the manufacturer, such as the remote computing device 106.

The cloud computing environment may identify one or more locations based on the one or more images, wherein the identified one or more locations are indicative of wear and tear. The cloud computing environment may create a two-dimensional (2-D) pattern based on the identified one or more locations and/or the one or more images. The cloud computing environment may determine a severity degree associated with each of the one or more identified locations. The cloud computing environment may send instructions to create one or more articles (e.g., a pair of uppers for shoes) based on the 2-D pattern and/or the one or more determined severity degrees to a device (e.g., machine, knitting machine, computing device), such as the manufacturing machine 108. As an example, the manufacturing machine 108 may construct or fabricate a custom pair of uppers for shoes for the user based on her particular wear on the pair of shoes. Although reference is made to uppers for shoes, other footwear components may be made such as a midsole or outsole, or apparel components or accessories.

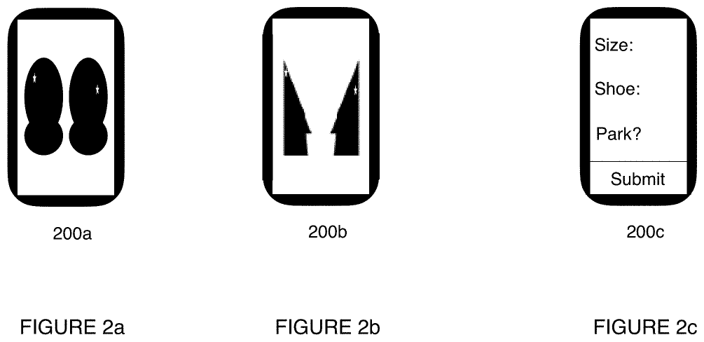

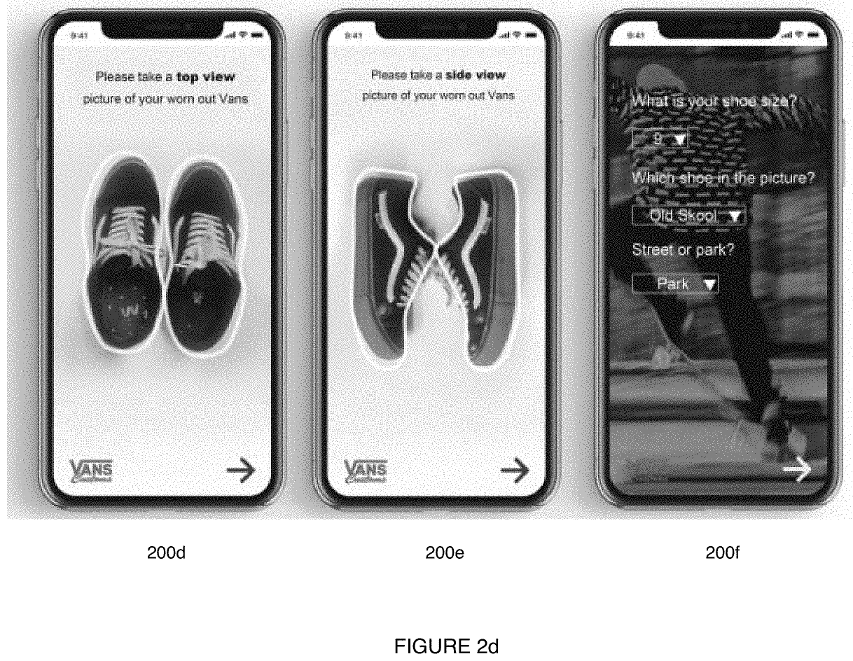

FIGS. 2a-2d show example user interfaces for making custom articles such as footwear, apparel, or accessories. FIG. 2a shows user interface 200a accepting a top-down view image of an article (e.g., a first pair of shoes). Similarly, user interface 200d in FIG. 2d shows the user interface 200d accepting a top-down view image of a second article (e.g., a second pair of shoes). FIG. 2b shows user interface 200b accepting a side view image of the first pair of shoes. Similarly, user interface 200d in FIG. 2d shows the user interface 200e accepting a side view image of the second pair of shoes. FIG. 2c shows user interface 200c accepting form information about the first pair of shoes. Similarly, user interface 200f in FIG. 2d shows the user interface 200f accepting form information about the second pair of shoes. Form information may comprise shoe size, shoe type, use or activity, and/or any combination of the foregoing. The application may comprise the user interfaces 200a, 200b, 200c, 200d, 200e, 200f. The application may guide the user to take the top-down view images, the side images, and fill out the form information. The application may be a web responsive application. Although reference is made to pairs of shoes in the 2a-2d, other components may be made such as footwear components, apparel components or accessories.

The application may capture the top-down view images and/or the side view images. The application may process the top-down view images and/or the side view images. The application may use image extraction to define the boundaries of the shoes in the images and remove everything else. The application may use data transformation to align multiple images of the same shoe or shoe pair. The application may be in communication with an artificial intelligence (AI) engine via an application programming interface (API) to help identify the boundaries of the shoes. After receiving the images and the form information from the user, the application may cause the images and the form information to be transmitted across a network to a back-end computing system, such as the remote computing device 106 in FIG. 1.

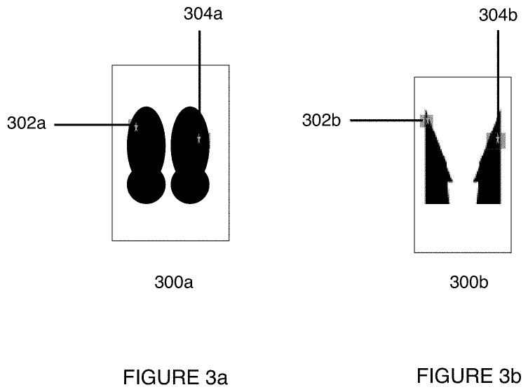

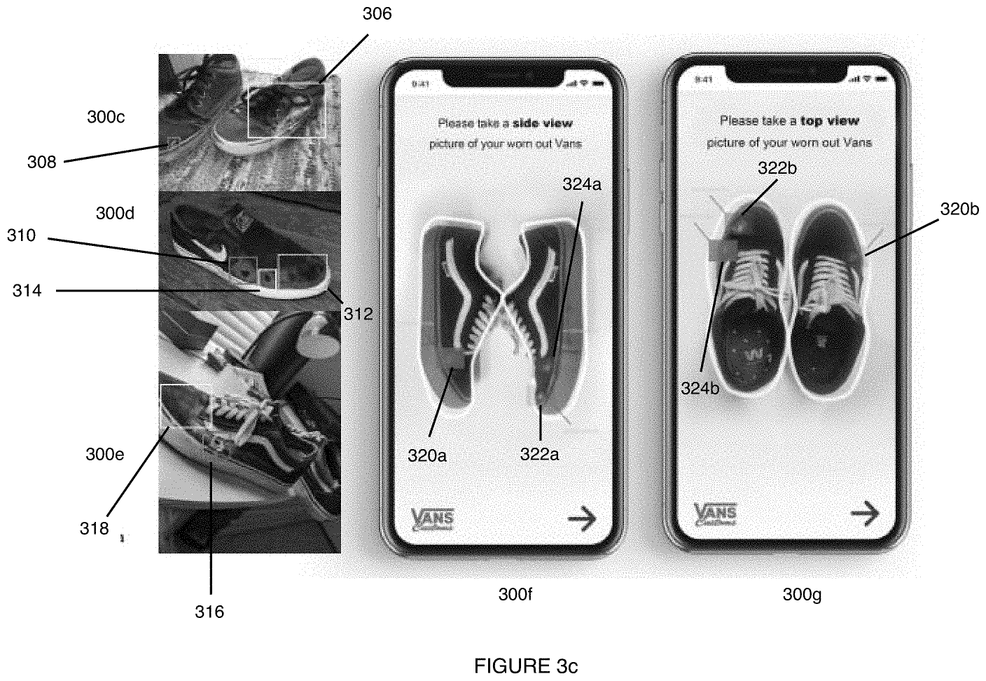

FIGS. 3a-3c show example applications for making custom footwear. More specifically, FIGS. 3a-3c show possible outputs or visualization of outputs of a back-end of an application. The back-end of the application may comprise a back-end visual recognition engine. The back-end of the application may be built on a convolutional neural network. The back-end of the application may be trained on shoe data to identify worn-out upper areas from shoe images. The back-end of the application may identify worn-out upper areas from shoe images with an accuracy of 75% or greater. Although reference is made to training and/or testing a model (e.g., AI-based model, neural network, etc.) on footwear images, other training or testing data may be used and applied to specific articles of footwear, apparel, or accessories.

The back-end of the application may collect images for training. The back-end of the application may use image digitization to model readable data. The back-end of the application may use data cleaning to remove noise from image data, such as top-down view and side view images of shoes. The back-end of the application may split the image data and prepare the image data for modeling. The back-end of the application may select a particular algorithm from a plurality of images to use for a particular image of a shoe. The back-end of the application may comprise a modeling pipeline for identifying worn areas on a shoe. The back-end of the application may use model training and/or tuning to teach a model to learn patterns from images of shoes. The back-end of the application may determine an evaluation of a model for identifying worn areas in a shoe. The back-end of the application may send model reports to a user interface of an application, such the application comprising the user interfaces shown in FIGS. 2a-d. A module of the back-end of the application may receive one or more images of shoes as input and may output identifications of worn-out areas (e.g., locations, etc.) on the received one or more images of the shoes.

FIG. 3a shows visualization of output 330a. The visualization of output 330a identifies a first location 302a and a second location 304a of wear and tear in the top-down view image received from interface 200a in FIG. 2a. FIG. 3b shows visualization of output 330b. The visualization of output 330b identifies the first location 302b and the second location 304b of wear and tear in the side view image received from interface 200b in FIG. 2b.

Similarly, FIG. 3c shows visualizations of output 300c (with a first location 306 and a second location 308 of wear and tear on a first random pair of shoes), 300d (with a first location 310, a second location 312, and a third location 314 of wear and tear on a second random pair of shoes), and 300e (with a first location 316 and a second location 318 of wear and tear on a third random pair of shoes). Additionally, FIG. 3c shows visualization of output 300f The visualization of output 300f identifies a first location 320a, a second location 322a, and a third location 324a of wear and tear in the side view image received from the interface 200e in FIG. 2d. Finally, FIG. 3c shows visualization of output 300g. The visualization of output 300g identifies the first location 320b, the second location 322b, and the third location 324b of wear and tear in the top-down view image received from the interface 200d in FIG. 2d.

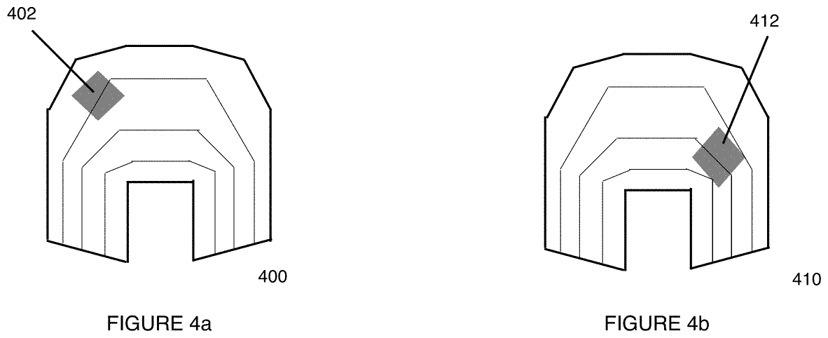

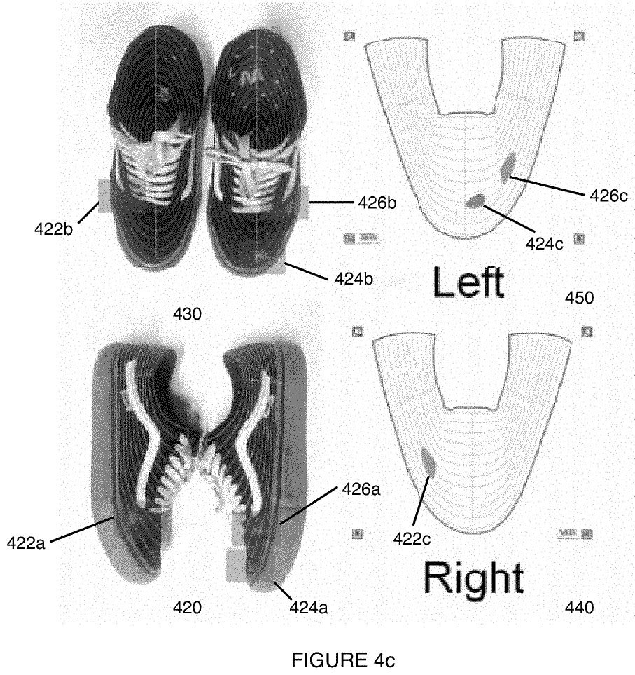

FIGS. 4a-4c show example mappings for making custom footwear. Although reference is made to knit uppers, the present mapping and processing techniques may be applied to other materials, footwear components, apparel components, or accessories. The back-end of the application may map the images of shoes received from a front-end instance of the application and the associated locations identified by the back-end of the application, as described in FIGS. 3a-3c, to create (e.g., output, generate, etc.) a two-dimensional (2-D) pattern. The back-end of the application may comprise a three-dimensional (3-D) to 2-D position system, which uses point-to-point (PTP) positioning technology to map worn-out areas from one or more images of a 3-D upper for a shoe to a 2-D pattern of an upper for a shoe. The back-end of the application may use a positioning system to move predefined 3-D points based on the one or more images to a predefined 2-D location. The back-end of the application may map one object (e.g., a location of wear and tear on a shoe) to another (e.g., a location on a pattern that may approximate the location of wear and tear on the shoe) with the coordinate system.

The back-end of the application may comprise the coordinate system. The back-end of the application may comprise a 3-D digital model. The back-end of the application may comprise a 2-D digital model. The back-end of the application may comprise a 3-D to 2-D PTP mapping module.

FIG. 4a shows a mapping 400 for a left upper for a shoe of the shoe pair shown in 300a in FIGS. 3a and 300b in FIG. 3b. Area 402 in mapping 400 may represent an area of extra material (e.g., reinforcement, etc.) to compensate for the first location of wear and tear 302a in FIGS. 3a and 302b in FIG. 3b. Area 402 in mapping 400 may represent an area of extra knitting (e.g., knit reinforcement, etc.) to compensate for the first location of wear and tear 302a in FIGS. 3a and 302b in FIG. 3b.

FIG. 4b shows a mapping 410 for a right upper for a shoe of the shoe pair shown in 300a in FIGS. 3a and 300b in FIG. 3b. Area 412 in mapping 410 may represent an area of extra material to compensate for the second location of wear and tear 304a in FIGS. 3a and 304b in FIG. 3b. Area 412 in mapping 410 may represent an area of extra knitting to compensate for the second location of wear and tear 304a in FIGS. 3a and 304b in FIG. 3b.

FIG. 4c shows visualization of output 420, which is similar to the visualization of output 300f in FIG. 3c. The visualization of output 420 identifies a first location 422a, a second location 424a, and a third location 426a of wear and tear. FIG. 4c shows visualization of output 430, which is similar to the visualization of output 300g in FIG. 3c. The visualization of output 430 identifies the first location 422b, a second location 424b, and a third location 426b of wear and tear.

Mapping 440 shows a mapping for a pattern for a right upper for a shoe.

Mapping 440 comprises area 422c to compensate for the first location 422a, 422b. Area 422c may receive extra material. Area 422c may receive extra knitting material. Mapping 450 shows a mapping for a pattern for a left upper for a shoe. Mapping 450 comprises area 424c to compensate for the second location 424a, 424b. Area 424c may receive extra material. Area 424c may receive extra knitting material. Mapping 450 comprises area 426c to compensate for the third location 426a, 426b. Area 426c may receive extra material. Area 426c may receive extra knitting material.

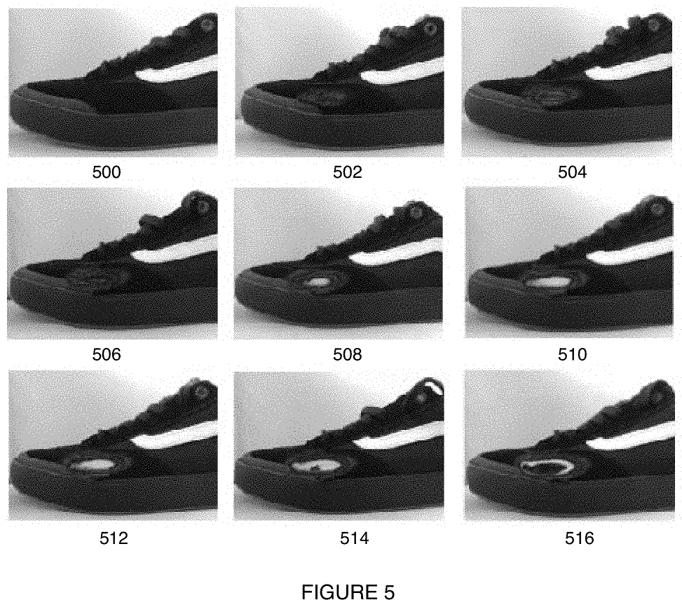

FIG. 5 shows images 500, 502, 504, 506, 508, 510, 512, 514, 516 of example severities of wear and tear of footwear. The images may start with a lowest degree of severity of wear and tear at the upper left image (image 500) and increase in degree of severity of wear and tear first from left-to-right and then downward. So image 502 may show an increase in degree of severity of wear and tear from image 500, image 504 may show an increase in degree of severity of wear and tear from image 502, and so on until a highest degree of severity of wear and tear is reached at the lower right image (image 516).

The back-end of the application may be trained to recognize patterns and regularities in data automatically using training data comprising images of worn articles (e.g., shoes), such as images 500, 502, 504, 506, 508, 510, 512, 514, 516. The back-end of the application may use AI and/or machine learning to determine severity degrees of worn areas. The back-end of the application may use computer vision to determine severity degrees of worn areas. The back-end of the application may use image digitization to determine severity degrees of worn areas. The back-end of the application may use data mining to determine severity degrees of worn areas. The back-end of the application may use user input to determine severity degrees of worn areas. The back-end of the application may use knowledge discovery in image databases to determine severity degrees of worn areas.

The back-end of the application may prepare severity data, such as images 500, 502, 504, 506, 508, 510, 512, 514, 516. The back-end of the application may select an algorithm for severity degree determination. The back-end of the application may comprise a severity assessment model. The back-end of the application may comprise severity assessment model training and/or tuning. The back-end of the application may comprise severity assessment model evaluation. The back-end of the application may comprise severity assessment reporting to a front-end instance of the application.

The back-end of the application may comprise a severity degree identification engine. The back-end of the application may comprise a deep regression neural network. The back-end of the application may be trained on worn-out severity data, such as images 500, 502, 504, 506, 508, 510, 512, 514, 516, to automatically assess a degree of severity from an image of an upper of a shoe. Severity may be represented on a scale (e.g., color or numerical) or by thresholds (e.g., pre-defined categories). The back-end application may receive an image of worn shoes and output a severity degree associated with each worn area.

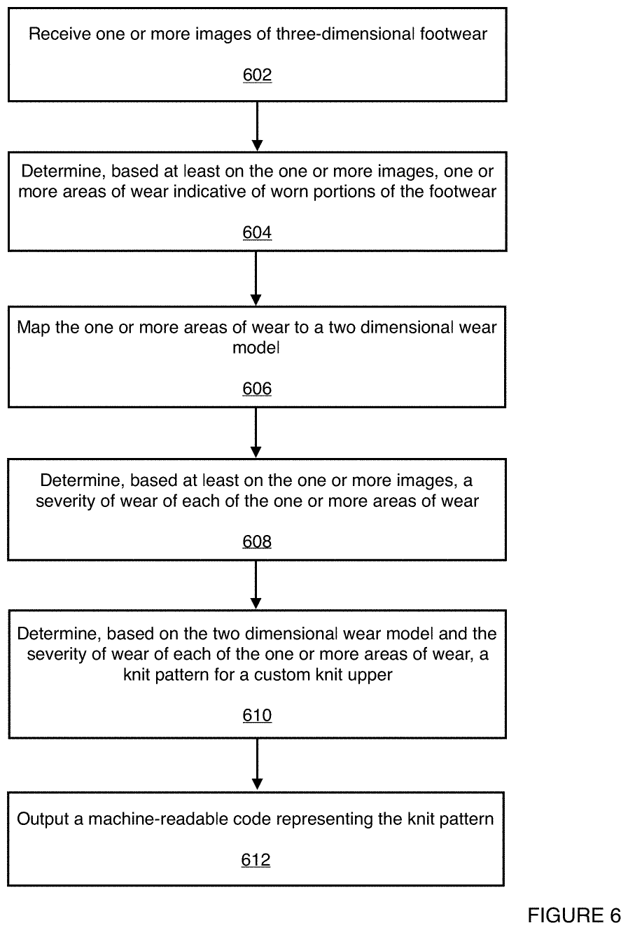

FIG. 6 shows a flow diagram for making custom knit footwear. At step 602, one or more images of three-dimensional articles such as footwear or apparel may be received. The remote computing device 106 in FIG. 1 may receive one or more images of three-dimensional footwear. The one or more images may be received via a mobile application. The one or more images may comprise a top-down view or a side view, or both. Additional information may be received such as historical data, including, but limited to, purchase history, style preferences associated with a wearer or group of wearers, and/or expert input relating to style or end use, etc.

At step 604, one or more areas of wear indicative of worn portions of the footwear may be determined based at least on the one or more images. The remote computing device 106 in FIG. 1 may determine one or more areas of wear indicative of worn portions of the footwear based at least on the one or more images. The one or more areas of wear may be determined using computer vision. The one or more areas of wear may be determined using a machine learning algorithm trained on a plurality of footwear images.

At step 606, the one or more areas of wear may be mapped to a two dimensional wear model. The remote computing device 106 in FIG. 1 may map the one or more areas of wear to a two dimensional wear model. The mapping may comprise point-to-point positioning. The two dimensional model may be based on a pattern of a footwear upper.

At step 608, a severity of wear of each of the one or more areas of wear may be determined based at least on the one or more images. The remote computing device 106 in FIG. 1 may determine a severity of wear of each of the one or more areas of wear based at least on the one or more images. The severity of wear may be determined using a machine learning algorithm trained on a plurality of images (e.g., footwear, apparel and/or accessory component images).

At step 610, a custom pattern such as a knit pattern may be determined for a custom knit upper based on the two dimensional wear model and the severity of wear of each of the one or more areas of wear. Although a knit pattern is referenced for illustration, other material patterns or components may be used such as upper, midsole, outsole, or apparel, or accessories. The remote computing device 106 in FIG. 1 may determine a knit pattern for a custom knit upper based on the two dimensional wear model and the severity of wear of each of the one or more areas of wear. The knit pattern may comprise a reinforced region spatially disposed based on a location of the one or more areas of wear. The knit pattern may comprise a reinforced region spatially disposed based on the severity of wear of the one or more areas of wear. The knit pattern may comprise a reinforced region spatially disposed based on a location and severity of wear of the one or more areas of wear.

At step 612, a machine-readable code representing the knit pattern may be outputted. The remote computing device 106 in FIG. 1 may output a machine-readable code representing the knit pattern. The machine-readable code may be configured to be processed by a knitting machine to cause knitting of at least a portion of the custom knit upper. Other manufacturing and/or assembly techniques may be used to form various components of footwear, apparel, or accessories, as mentioned herein.

As an example, rather than generating a custom knit pattern, one or more available pre-set patterns may be selected based on the two dimensional wear model and the severity of wear of each of the one or more areas of wear. As an example, steps 610 and 612 may be embodied as a suggestion engine that recommends an available article from a pre-set catalogue (e.g., inline styles) that best matches the custom article based on the two dimensional wear model and the severity of wear. As used herein, “inline style” may refer to one or a plurality of pre-designed styles for a particular season (or seasons) of footwear, apparel or accessories. Other inputs may be used, such as expert feedback, historical style data (i.e., of the user/purchaser), preference data for a particular wearer or activity, etc. Suggestion engine recommendations may be based on a single user or may be aggregated based on preferences of cohorts or other like users.

An article, such as an article of footwear or component thereof, apparel or a component thereof, or an accessory or component thereof, may be manufactured using any combination of any portions of the steps described in FIG. 6. As an example, the article may comprise a skate shoe. In such an example, a skateboarder may perform a series of signature tricks. Performance of the series of signature tricks may cause shoes of the skateboarder to experience wear in particular areas. The skateboarder may take one or more top-down view pictures and/or one or more side view pictures of the shoes with a mobile device. The mobile device may be executing a mobile application. The mobile application may cause the one or more pictures of the shoes to be transmitted across a network to a remote computing device. The remote computing device may be associated with a shoe manufacturer. The remote computing device may locate areas of wear and tear on the shoes. The remote computing device may determine a severity of each located area of wear and tear. The remote computing device may be in communication with a knitting machine. The remote computing device may cause the knitting machine to make custom knit uppers for shoes for the skateboarder based on the determined severities of each located area of wear and tear. Although reference is made to a skate shoe, images of other footwear or footwear components, such as a midsole or outsole, or apparel components or accessories may be received by the remote computing device for a severity determination and manufacturing instruction communication manufacturing and/or assembly machines or devices.

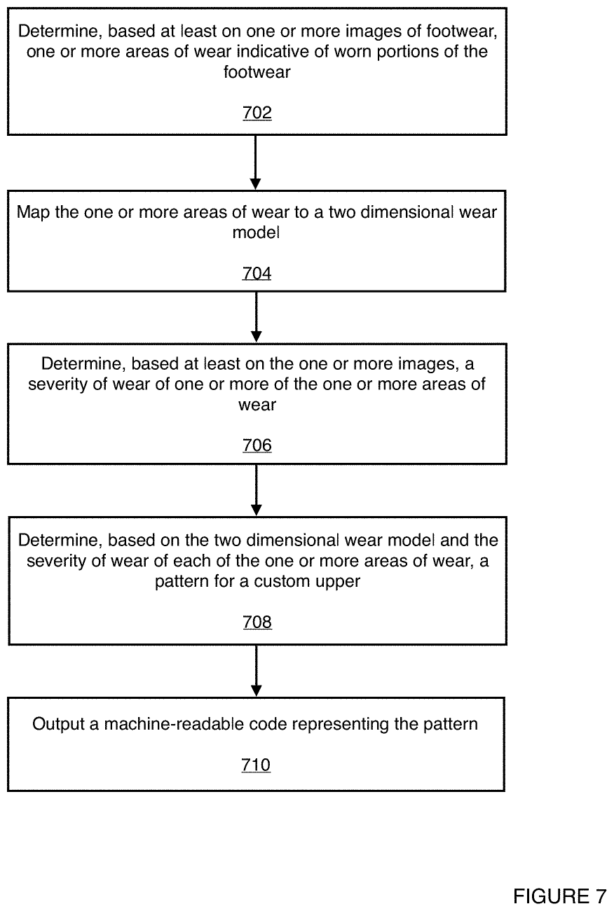

FIG. 7 shows a flow diagram for making a custom article (e.g., custom footwear). At step 702, one or more areas of wear indicative of worn portions of an article such as footwear may be determined based at least on one or more images of the footwear. The remote computing device 106 in FIG. 1 may determine one or more areas of wear indicative of worn portions of footwear based at least on one or more images of the footwear. The one or more images may be received via a mobile application. The one or more images may comprise a top-down view or a side view, or both. The one or more areas of wear may be determined using computer vision. The one or more areas of wear may be determined using a machine learning algorithm trained on a plurality of article (e.g., footwear) images.

At step 704, the one or more areas of wear may be mapped to a two dimensional wear model. The remote computing device 106 in FIG. 1 may map the one or more areas of wear to a two dimensional wear model. The mapping may comprise point-to-point positioning. In the example of footwear, the two dimensional model may be based on a pattern of a footwear upper.

At step 706, a severity of wear of one or more of the one or more areas of wear may be determined based at least on the one or more images. The remote computing device 106 in FIG. 1 may determine a severity of wear of one or more of the one or more areas of wear based at least on the one or more images. The severity of wear may be determined using a machine learning algorithm trained on a plurality of footwear images.

At step 708, a pattern may be determined for a custom component such as a footwear upper based on the two dimensional wear model and the severity of wear of each of the one or more areas of wear. Determining a custom component may comprise selecting an available component from a pre-set catalogue (e.g., inline styles) of available patterns or components. Additionally or alternatively, a custom component may be specifically designed for a particular user on an ad hoc basis. Determining a custom component may be based on historical data, wearer information, wearer style, expert input, or the like. The remote computing device 106 in FIG. 1 may determine a pattern for a custom upper based on the two dimensional wear model and the severity of wear of at least one, more than one, or each of the one or more areas of wear. The pattern may comprise a reinforced region spatially disposed based on a location of the one or more areas of wear. The pattern may comprise a reinforced region spatially disposed based on the severity of wear of the one or more areas of wear. The pattern may comprise a reinforced region spatially disposed based on a location and severity of wear of the one or more areas of wear.

At step 710, a machine-readable code representing the pattern may be outputted. The remote computing device 106 in FIG. 1 may output a machine-readable code representing the pattern. The machine-readable code may be configured to be processed by a machine to cause manufacture of at least a portion of the custom upper. Other manufacturing and assembly techniques may be used such as digital printing, robotic assembly, stitching, knitting, adhering, welding, laminating, etc. Various components may be produced such as a footwear components, apparel components, or accessories.

An article, such as an article of footwear or component thereof, apparel or a component thereof, or an accessory or component thereof, may be manufactured using any combination of any portions of the steps described in FIG. 7. The article may comprise a skate shoe. In such an example, a skateboarder may perform a series of signature tricks. Performance of the series of signature tricks may cause shoes of the skateboarder to experience wear in particular areas. The skateboarder may take one or more top-down view pictures and/or one or more side view pictures of the shoes with a mobile device. The mobile device may be executing a mobile application. The mobile application may cause the one or more pictures of the shoes to be transmitted across a network to a remote computing device. The remote computing device may be associated with a shoe manufacturer. The remote computing device may locate areas of wear and tear on the shoes. The remote computing device may determine a severity of each located area of wear and tear. The remote computing device may be in communication with a manufacturing machine. The remote computing device may cause the manufacturing machine to make custom uppers for the skate shoe(s) based on the determined severities of each located area of wear and tear. Although reference is made to a skate shoe, images of other footwear or footwear components, such as a midsole or outsole, or apparel components or accessories may be received by the remote computing device for a severity determination and manufacturing instruction communication manufacturing and/or assembly machines or devices.

Additionally or alternatively, the present disclosure relates to receiving image data (e.g., directly from a wearer) such as images of worn articles (e.g., footwear or apparel). Images and/or other information may be received over a period of time, for example, to develop a history of wear and a personalized wear experience. As a non-limiting example, expert information may be received that relates to the article and/or an end-use. As an illustration, a subject-matter expert may review the history of wear or other details relating to a wearer and may provide expert information relating to style or wear. A technical skate expert may advise on the type of skate style a particular wearer may have, and thus the skate style may be used to determine an expect wear pattern. An expert trail runner may advise on the type of running style a particular wearer may have, and thus the runner style may be used to determine an expect wear pattern. A model may be created representing the wearer style and end-use needs. The model may comprise AI-based or machine learning based models. The model may be trained or tested on data such as image data. The model may be tuned based on expert information or other details relating to the wearer. From the model, a suggestion of an inline article may be provided to a wearer. Additionally or alternatively, a customized article may be manufactured (e.g., on demand) based on the model for the particular wearer.

### EXAMPLES

Example 1: A method of making custom knit footwear, the method comprising:
receiving one or more images of three-dimensional footwear; determining, based at least on the one or more images, one or more areas of wear indicative of worn portions of the footwear; mapping the one or more areas of wear to a two dimensional wear model; determining, based at least on the one or more images, a severity of wear of each of the one or more areas of wear; determining, based on the two dimensional wear model and the severity of wear of each of the one or more areas of wear, a knit pattern for a custom knit upper; and outputting a machine-readable code representing the knit pattern, wherein the machine-readable code is configured to be processed by a knitting machine to cause knitting of at least a portion of the custom knit upper.

Example 2: The method of example 1, wherein the one or more images are received via a mobile application.

Example 3: The method of any of examples 1-2, wherein the one or more images comprises a top-down view or a side view, or both.

Example 4: The method of any of examples 1-3, wherein the one or more areas of wear are determined using computer vision.

Example 5: The method of any of examples 1-4, wherein the one or more areas of wear are determined using a machine learning algorithm trained on a plurality of footwear images.

Example 6: The method of any of examples 1-5, wherein the mapping comprises point-to-point positioning.

Example 7: The method of any of examples 1-6, wherein the two dimensional model is based on a pattern of a footwear upper.

Example 8: The method of any of examples 1-7, wherein the severity of wear is determined using a machine learning algorithm trained on a plurality of footwear images.

Example 9: The method of any of examples 1-8, wherein the knit pattern comprises a reinforced region spatially disposed based on a location of the one or more areas of wear.

Example 10: The method of any of examples 1-9, wherein the knit pattern comprises a reinforced region spatially disposed based on the severity of wear of the one or more areas of wear.

Example 11: The method of any of examples 1-10, wherein the knit pattern comprises a reinforced region spatially disposed based on a location and severity of wear of the one or more areas of wear.

Example 12: An article of footwear manufactured using the method of any one of examples 1-11.

Example 13: The article of example 12, wherein the article comprises a skate shoe.

Example 14: A method of making custom footwear, the method comprising:
determining, based at least on one or more images of footwear, one or more areas of wear indicative of worn portions of the footwear; mapping the one or more areas of wear to a two dimensional wear model; determining, based at least on the one or more images, a severity of wear of one or more of the one or more areas of wear; determining, based on the two dimensional wear model and the severity of wear of each of the one or more areas of wear, a pattern for a custom upper; and outputting a machine-readable code representing the pattern, wherein the machine-readable code is configured to be processed by a machine to cause manufacture of at least a portion of the custom upper.

Example 15: The method of any of examples 1-11 or 14, wherein the one or more images are received via a mobile application.

Example 16: The method of any of examples 1-11 or 14-15, wherein the one or more images comprises a top-down view or a side view, or both.

Example 17: The method of any of examples 1-11 or 14-16, wherein the one or more areas of wear are determined using computer vision.

Example 18: The method of any of examples 1-11 or 14-17, wherein the one or more areas of wear are determined using a machine learning algorithm trained on a plurality of footwear images.

Example 19: The method of any of examples 1-11 or 14-18, wherein the mapping comprises point-to-point positioning.

Example 20: The method of any of examples 1-11 or 14-19, wherein the two dimensional model is based on a pattern of a footwear upper.

Example 21: The method of any of examples 1-11 or 14-20, wherein the severity of wear is determined using a machine learning algorithm trained on a plurality of footwear images.

Example 22: The method of any of examples 1-11 or 14-21, wherein the pattern comprises a reinforced region spatially disposed based on a location of the one or more areas of wear.

Example 23: The method of any of examples 1-11 or 14-22, wherein the pattern comprises a reinforced region spatially disposed based on the severity of wear of the one or more areas of wear.

Example 24: The method of any of examples 1-11 or 14-23, wherein the pattern comprises a reinforced region spatially disposed based on a location and severity of wear of the one or more areas of wear.

Example 25: An article of footwear manufactured using the method of any one of examples 1-11 or 14-24.

Example 26: The article of example 25, wherein the article comprises a skate shoe.

Example 27: A method of making a custom article, the method comprising: receiving one or more images of a three-dimensional article; determining, based at least on the one or more images, one or more areas of wear indicative of worn portions of the article; mapping the one or more areas of wear to a two dimensional wear model; determining, based at least on the one or more images, a severity of wear of each of the one or more areas of wear; determining, based on the two dimensional wear model and the severity of wear of each of the one or more areas of wear, a pattern for a custom article; and outputting a machine-readable code representing the pattern, wherein the machine-readable code is configured to be processed by a machine to cause formation of at least a portion of the custom article.

Example 28: The method of claim 27, wherein the pattern comprises an outsole, a midsole, or an upper, or a component of apparel.

Example 29: The method of any one of claims 27-28, wherein the one or more images are received via a mobile application.

Example 30: The method of any one of claims 27-29, wherein the one or more images comprises a top-down view or a side view, or both.

Example 31: The method of any one of claims 27-30, wherein the one or more areas of wear are determined using computer vision.

Example 32: The method of any one of claims 27-31, wherein the one or more areas of wear are determined using a machine learning algorithm trained on a plurality of article images having various wear patterns.

Example 33: The method of any one of claims 27-32, wherein the mapping comprises point-to-point positioning.

Example 34: The method of any one of claims 27-33, wherein the severity of wear is determined using a machine learning algorithm trained on a plurality of article images.

Example 35: The method of any one of claims 27-34, wherein the pattern comprises a reinforced region spatially disposed based on a location of the one or more areas of wear.

Example 36: The method of any one of claims 27-35, wherein the pattern comprises a reinforced region spatially disposed based on the severity of wear of the one or more areas of wear.

Example 37: The method of any one of claims 27-36, wherein the pattern comprises a reinforced region spatially disposed based on a location and severity of wear of the one or more areas of wear.

Example 38: An article of footwear manufactured using the method of any one of claims 27-37.

Example 39: The article of claim 38, wherein the article comprises a skate shoe.

1. A method of making custom knit footwear, the method comprising:
receiving one or more images of three-dimensional footwear;
determining, based at least on the one or more images, one or more areas of wear indicative of worn portions of the footwear;
mapping the one or more areas of wear to a two dimensional wear model;
determining, based at least on the one or more images, a severity of wear of each of the one or more areas of wear;
determining, based on the two dimensional wear model and the severity of wear of each of the one or more areas of wear, a knit pattern for a custom knit upper; and
outputting a machine-readable code representing the knit pattern, wherein the machine-readable code is configured to be processed by a knitting machine to cause knitting of at least a portion of the custom knit upper.

2. The method of claim 1, wherein the one or more images are received via a mobile application. The method of claim 1, wherein the one or more images comprises a top-down view or a side view, or both.

4. The method of claim 1, wherein the one or more areas of wear are determined using computer vision.

5. The method of claim 1, wherein the one or more areas of wear are determined using a machine learning algorithm trained on a plurality of footwear images.

6. The method of claim 1, wherein the mapping comprises point-to-point positioning.

7. The method of claim 1, wherein the two dimensional model is based on a pattern of a footwear upper.

8. The method of claim 1, wherein the severity of wear is determined using a machine learning algorithm trained on a plurality of footwear images.

9. The method of claim 1, wherein the knit pattern comprises a reinforced region spatially disposed based on a location of the one or more areas of wear.

10. The method of claim 1, wherein the knit pattern comprises a reinforced region spatially disposed based on the severity of wear of the one or more areas of wear.

11. The method of claim 1, wherein the knit pattern comprises a reinforced region spatially disposed based on a location and severity of wear of the one or more areas of wear.

12. An article of footwear manufactured using the method of claim 1.

13. The article of claim 12, wherein the article comprises a skate shoe.

14. A method of making custom footwear, the method comprising:
determining, based at least on one or more images of footwear, one or more areas of wear indicative of worn portions of the footwear;
mapping the one or more areas of wear to a two dimensional wear model;
determining, based at least on the one or more images, a severity of wear of one or more of the one or more areas of wear;
determining, based on the two dimensional wear model and the severity of wear of each of the one or more areas of wear, a pattern for a custom upper; and
outputting a machine-readable code representing the pattern, wherein the machine-readable code is configured to be processed by a machine to cause manufacture of at least a portion of the custom upper.

15. A method of making a custom article, the method comprising:
receiving one or more images of a three-dimensional article;
determining, based at least on the one or more images, one or more areas of wear indicative of worn portions of the article;
mapping the one or more areas of wear to a two dimensional wear model;
determining, based at least on the one or more images, a severity of wear of each of the one or more areas of wear;
determining, based on the two dimensional wear model and the severity of wear of each of the one or more areas of wear, a pattern for a custom article; and
outputting a machine-readable code representing the pattern, wherein the machine-readable code is configured to be processed by a machine to cause formation of at least a portion of the custom article.

16. The method of claim 15, wherein the pattern comprises an outsole, a midsole, or an upper, or a component of apparel.

17. The method of claim 15, wherein the one or more images are received via a mobile application. The method of claim 15, wherein the one or more images comprises a top-down view or a side view, or both.

19. The method of claim 15, wherein the one or more areas of wear are determined using computer vision.

20. The method of claim 15, wherein the one or more areas of wear are determined using a machine learning algorithm trained on a plurality of article images having various wear patterns.

21. The method of claim 15, wherein the mapping comprises point-to-point positioning.

22. The method of claim 15, wherein the severity of wear is determined using a machine learning algorithm trained on a plurality of article images.

23. The method of claim 15, wherein the pattern comprises a reinforced region spatially disposed based on a location of the one or more areas of wear.

24. The method of claim 15, wherein the pattern comprises a reinforced region spatially disposed based on the severity of wear of the one or more areas of wear.

25. The method of claim 15, wherein the pattern comprises a reinforced region spatially disposed based on a location and severity of wear of the one or more areas of wear.

26. An article manufactured using the method of claim 15.
